(19) United States
(12) Patent Application Publication
(10) Pub. No.: US 2008/0239149 A1
(43) Pub. Date: Oct. 2, 2008

(54) OSD system having colorful and dynamic OSD menu and method for controlling same

(75) Inventors: Jing-Zhou Lai, Shenzhen (CN); Hu-Da Gu La, Shenzhen (CN); Kuang-Liang Huang, Miao-Li (TW); Chun-Rong Song, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/080,014

(22) Filed: Mar. 31, 2008

(30) Foreign Application Priority Data
Mar. 30, 2007 (CN) 200710073759.2

(51) Int. Cl. H04N 5/50

(52) U.S. Cl. 348/569; 348/E05.097

(57) ABSTRACT

An exemplary on-screen display (OSD) system (3) includes a display device (5) and a computer (4) connected to the display device. The display device includes a micro processing unit (MPU) (532) configured for providing a plurality of instruction signals according to external instructions. The computer includes a memory (41) and a central processing unit (CPU) (42). The memory includes an external OSD unit (412) configured for generating an external OSD menu. The external OSD menu is colorful and dynamic. The CPU is configured for identifying the instruction signals from the MPU and providing control signals corresponding to the instruction signals. The external OSD unit is capable of setting and assigning data to generate the external OSD menu on receiving the control signals from the CPU, whereupon the external OSD menu is displayed on the display device.

### FIELD OF THE INVENTION

The present invention relates to an on-screen display (OSD) system having a colorful and dynamic OSD menu, and a method for controlling the OSD system.

### BACKGROUND

In general, a display device is used with an apparatus such as a computer in order to show data generated by the computer. The most popular display devices can be considered to be cathode ray tube (CRT) devices and liquid crystal display (LCD) devices.

When used with a computer (for example), such kinds of display devices commonly have an OSD function. The OSD function is for displaying information relating to adjusting of display characteristics of video signal transmitted from the computer, as well as information about the display device itself. The display device and the computer cooperatively constitute an OSD system. The OSD activated on the screen of the display device generally includes an OSD menu for altering information associated with parameters of the display device. The OSD menu is typically composed of single-colored characters, which generally show the display parameters in the form of numerals within ranges or in the form of scale bars. Thus, the display device can achieve a preferred display performance by a user adjusting the settings of the display parameters via the OSD menu.

Referring to FIG. 4, a typical OSD system 1 includes an inputting unit 10, a display screen 12, and a controlling circuit 14. The display screen 12 is incorporated in a display monitor (not shown).

The inputting unit 10 includes a selecting section 101 and at least one modulating section 102. By operating the selecting section 101, the OSD menu is invoked, and display parameters such as brightness, contrast, and color temperature can be selected respectively. By operating the modulating section 102, the settings of the display parameters are adjusted to desired values. The OSD controller 10 can be, for example, a keyboard, a mouse, or a series of buttons arranged at the display monitor. The selecting section 101 can be, for example, a “menu” button of the display monitor. The modulating section 102 can be, for example, a “+” and/or “−” button of the display monitor.

The controlling circuit 14 includes a micro processing unit (MPU) 141, and a scaler integrated circuit 143 connected to the MPU 141. The MPU 141 is configured for modulating OSD data adapted to a desired OSD menu 121 according to the display parameters set with the inputting unit 10. The scaler integrated circuit 143 is configured for receiving and storing the OSD data of the OSD menu 121, and scaling the OSD data of the OSD menu 121 to fit the display screen 12. Then, the OSD menu 121 is displayed on the display screen 12. Generally, the OSD data include: a character library configured for setting the font of the OSD menu; a window graphic library configured for setting shapes and sizes of icons of the OSD menu; a function program segment configured for setting function items of the OSD menu, each function item corresponding to a respective display parameter; and a motion program segment configured for programming and setting a motion relationship of the function items.

When a user operates the selecting section 101, the MPU 141 calls the OSD data that are stored in the scaler integrated circuit 143, and the OSD menu 121 is displayed on the display screen 12. Thus, the settings of the display parameters can be easily adjusted by a user operating the modulating section 102 according to the OSD menu 121.

The OSD data are stored in the scaler integrated circuit 143, and the scaler integrated circuit 143 typically has limited storage space and data processing capability. Therefore the OSD menu 121 generally has only single-colored characters, and can only display in still text, scale bars or patterns.

Therefore, a new OSD system and a method for controlling the OSD system that can overcome the above-described problems are desired.

### SUMMARY

An exemplary on-screen display (OSD) system includes a display device and a computer connected to the display device. The display device includes a micro processing unit (MPU) configured for providing a plurality of instruction signals according to a user's instructions. The computer includes a memory and a central processing unit (CPU). The memory includes an external OSD unit configured for generating an external OSD menu. The external OSD menu is colorfully and dynamically displayed. The CPU is configured for identifying the instruction signals from the MPU and providing control signals corresponding to the instruction signals. The external OSD unit is capable of setting and assigning data to generate the external OSD menu on receiving the control signals from the CPU, whereupon the external OSD menu is displayed by the display device.

Other novel features and advantages will become more apparent from the following detailed description when taken in conjunction with the accompanying drawings.

### BRIEF DESCRIPTION OF THE DRAWINGS

FIG. 1 is a block diagram of an OSD system according to an exemplary embodiment of the present invention, the OSD system including an internal OSD unit.

FIG. 2 is a block diagram of internal structure of the internal OSD unit.

FIG. 3 is a flowchart summarizing an exemplary method for controlling the OSD system of FIG. 1.

FIG. 4 is a block diagram of a conventional OSD system.

### DETAILED DESCRIPTION OF PREFERRED EMBODIMENTS

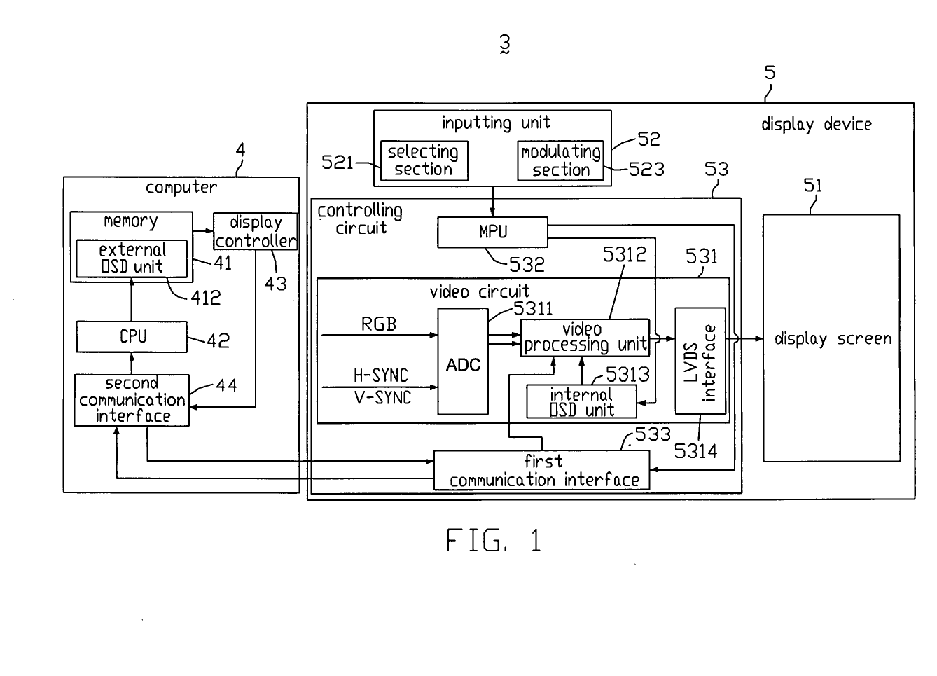

Referring to FIG. 1, an OSD system 3 according to an exemplary embodiment of the present invention is shown. The OSD system 3 is capable of providing a colorful and dynamic OSD menu that can be displayed on a display screen 51. The OSD system 3 includes a computer 4 and a display device 5. The display device 5 is connected with the computer 4 via a video signal wire, and video signals are transmitted between the computer 4 and the display device 5 according to I²C (inter integrated circuit) protocol. In this description, unless the context indicates otherwise, “colorful” includes the meaning of having plural colors or being multicolored. Unless the context indicates otherwise, “dynamic” includes the meaning of at least part of an image (or images) of a display moving at least some of the time during which the image (or images) is displayed.

The display device 5 includes an inputting unit 52, the display screen 51, and a controlling circuit 53. The display screen 51 can display images according to the video signals.

The inputting unit 52 is used for adjusting the OSD menu displayed on the display screen 51. The inputting unit 52 includes a selecting section 521 and a modulating section 523. The selecting section 521 is configured for selecting different function items, each function item corresponding to a particular display parameter of images that are shown on the display screen 51. The modulating section 523 is configured for adjusting the setting of each selected function item. The selecting section 521 and the modulating section 523 can be a plurality of push buttons, turn buttons, a key board, a mouse, and the like. The selecting section 521 and the modulating section 523 are operable to generate instruction signals, which are sent to the controlling circuit 53.

The controlling circuit 53 includes a micro processing unit (MPU) 532, a video circuit 531 configured for processing the video signals, and a first communication interface 533. The first communication interface 533 is configured for receiving various signals from the computer 4 and sending various signals to the computer 4. The video circuit 531 includes an analog to digital converter (ADC) 5311, a video processing unit 5312, an internal OSD unit 5313, and a low voltage differential signal (LVDS) interface 5314. The ADC 5311 is configured for receiving the video signals (including red, green, and blue picture signals) and synchronization signals (including horizontal and vertical synchronization signals) provided by external circuits, and converting the video signals and the synchronization signals into corresponding digital video signals and digital synchronization signals. The MPU 532 is configured for receiving the instruction signals from the inputting unit 52, and sending corresponding control signals to the internal OSD unit 5313. The internal OSD unit 5313 is configured for storing and processing first OSD data of an internal OSD menu (not shown). The internal OSD unit 5313 can assign and set the first OSD data according to the control signal provided by the MPU 532, thereby generating the internal OSD menu. Furthermore, the internal OSD menu includes a function item that is used for deciding whether to establish an active connection between the computer 4 and the inputting unit 52. The video processing unit 5312 is configured for scaling the digital signals received from the ADC 5311 and the first OSD data respectively, and then transmitting the scaled digital signals and the scaled first OSD data to the display screen 51 via the LVDS interface 5314. The display screen 51 thus displays the internal OSD menu.

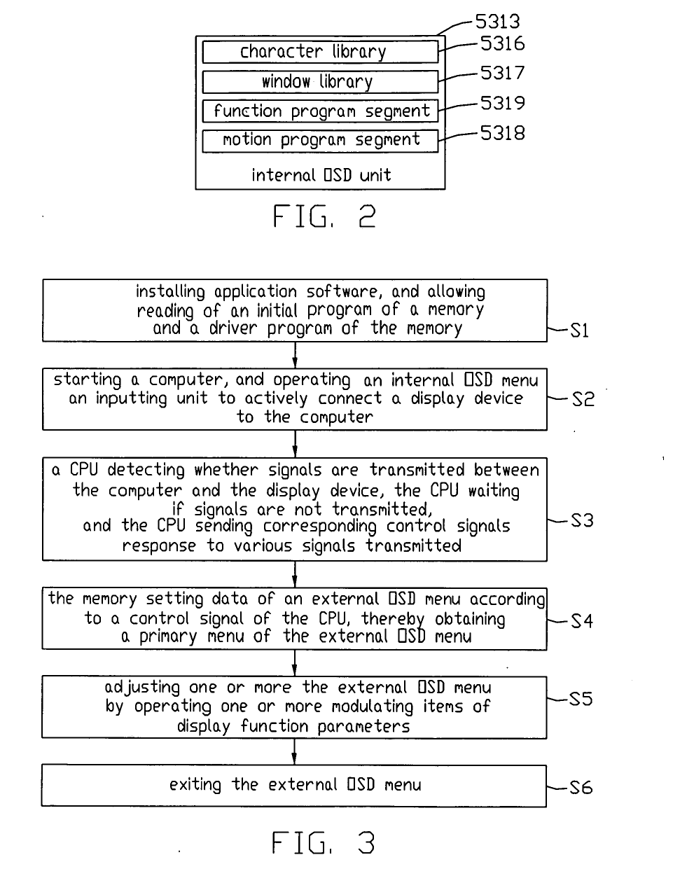

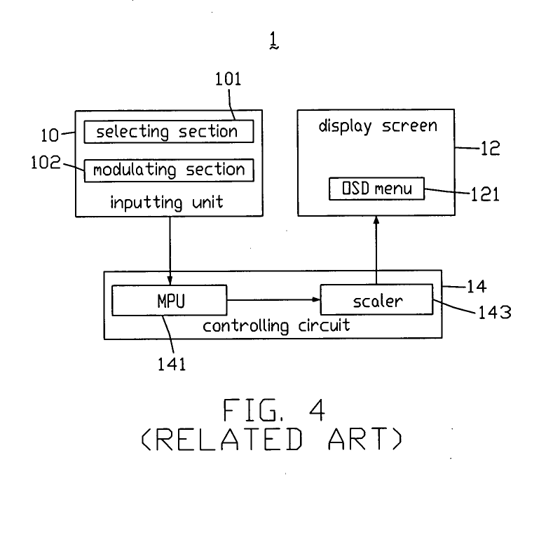

Referring also to FIG. 2, this is a block diagram of internal structure of the internal OSD unit 5313. The internal OSD unit 5313 includes a character library 5316, a window library 5317, a function program segment 5319, and a motion program segment 5318. The character library 5316 is configured for providing various characters and fonts for the internal OSD menu. The window library 5317 is configured for providing various window formats for the internal OSD menu. The function program segment 5319 is configured for setting various function items of the internal OSD menu. The motion program segment 5318 is configured for programming the function items of the internal OSD menu, and setting a dynamic relationship among the function items of the internal OSD menu. When the inputting unit 52 applies an instruction signal to the MPU 532 according to a user's instruction, the MPU 532 sends a corresponding control signal to the internal OSD unit 5313. The internal OSD unit 5313 calls the character library 5316 and the window library 5317 on receiving the control signal from the MPU 532, and thereby constructs the internal OSD menu. In addition, the internal OSD unit 5313 calls the function program segment 5319 and the motion program segment 5318 to finish the settings of the function items of the internal OSD menu.

The internal OSD menu is substantially a human-machine interactive interface. Users can easily adjust the settings of the display parameters of the display device 5 through the internal OSD menu. A user of the OSD system 3 can also input other controlling signals to the internal OSD unit 5313 through the internal OSD menu.

The computer 4 includes a memory 41, a central processing unit (CPU) 42, a display controller 43, and a second communication interface 44. The memory 41 includes an external OSD unit 412. The external OSD unit 412 is developed with dynamic image software such as FLASH® and is generally a data library programmed for a user's preference. The external OSD unit 412 substantially includes a plurality of libraries and program segments, which can provide an external OSD menu with different colors such as 256 colors (more than 64 colors) and a dynamic display.

The external OSD menu is also operable to establish an active connection between the computer 4 and the inputting unit 52. The external OSD menu includes a primary menu configured for displaying various function items of the external OSD menu, and a secondary menu configured for displaying modulating items of the function items of the external OSD menu. The display controller 43 is configured for receiving data of the external OSD menu from the memory 41, transforming the data of the external OSD menu into data signals, and transmitting the data signals to the second communication interface 44. The CPU 42 is capable of setting basic parameters of the external OSD menu and assigning resources of the data of the external OSD menu, thereby generating the external OSD menu. The data of the external OSD menu are transferred to the LVDS interface 5314 via the display controller 43, the second communication interface 44, the first communication interface 533, and the video processing unit 5312. The display screen 51 displays the external OSD menu upon receiving video signals from the LVDS interface 5314.

The active connection between the computer 4 and the display device 3 can be established through a user's operation on the inputting unit 52 according to the internal OSD menu. Then when the user operates the selecting section 521 again, the MPU 532 stops sending the control signals to the internal OSD unit 5313, and so the display screen 51 stops displaying the internal OSD menu. Furthermore, the MPU 532 sends an identification signal to the CPU 42 via the first communication interface 533 and the second communication interface 44. The CPU 42 receives and processes the identification signal, and controls the external OSD unit 412 of the memory 41 to set basic parameters of the external OSD menu and assign resources of the data of the external OSD menu according to a result of the processing, thereby generating the data of the external OSD menu. The data of the external OSD menu are processed and transmitted to the display screen 51, and the display screen 51 displays the external OSD menu. After that, the user can adjust a setting of any one or more of the function items included in the primary menu of the external OSD menu. In particular, the user performs such adjustment by operating one or more of the modulating items included in the secondary menu of the external OSD menu.

When the active connection between the computer 4 and the display device 5 is terminated due to accident or the user's instruction, the MPU 532 calls the internal OSD unit 5313, and the internal OSD menu is displayed on the display screen 51.

The memory 41 includes a non-volatile random access memory (NVRAM), which can for example be an electrically erasable programmable read-only memory (EEPROM). The NVRAM stores the data of the external OSD menu.

Referring to FIG. 3, a flowchart summarizing an exemplary method for controlling the OSD system is shown. The OSD controlling method includes: step S1, installing application software, and allowing reading of an initial program of a memory and a driver program of the memory; step S2, starting a computer, and operating an internal OSD menu through an inputting unit to actively connect a display device to the computer; step S3, a CPU detecting whether signals are transmitted between the computer and the display device, wherein the CPU keeps waiting if signals are not transmitted, and the CPU sends corresponding control signals in response to various signals transmitted; step S4, the memory setting data of an external OSD menu according to a control signal of the CPU, thereby obtaining a primary menu of the external OSD menu; step S5, adjusting one or more display function parameters by operating one or more corresponding modulating items of the external OSD menu; and step S6, exiting the external OSD menu.

In step S1, a user installs the application software, which includes an operating system, a word processing program, and an image processing program. The memory 41 is initialized. The initial program of the memory 41 allows the display device 5 and the computer 4 to actively communicate with each other, and the driving program of the memory 41 allows the memory 41 to be read and written.

In step S2, the user starts the computer 4, and establishes the active connection between the computer 4 and the display device 5 through operating the internal OSD menu.

In step S3, after the active connection between the computer 4 and the display device 5, the CPU 42 automatically detects whether there are signals transmitting from the second communication interface 44. If no signals are transmitting, the CPU 42 keeps waiting for an instruction. If the user inputs an instruction via the inputting unit 52, the MPU 532 generates corresponding signals that are transmitted to the CPU 42 via the first communication interface 533 and the second communication interface 44. The CPU 42 identifies the signals, and outputs corresponding control signals to the memory 41.

In step S4, the memory 41 calls the external OSD unit 412 to generate the primary menu of the external OSD menu in response to a corresponding control signal transmitted from the CPU 42. When the memory 41 calls the external OSD unit 412, the data of the external OSD menu stored in the second OSD unit 412 are transmitted to the display controller 43, and are then transformed into RGB signals. The RGB signals are then transmitted to the video processing unit 5312 via the second communication interface 44 and the first communication interface 533. The video processing unit 5312 scales the RGB signals, and transmits the scaled RGB signals to the display screen 51 via the LVDS interface 5314. Thus, the display screen 51 displays the primary menu of the external OSD menu.

In step S5, the user inputs an adjusting instruction through the modulating section 522 of the inputting unit 52 corresponding to one of the function items of the external OSD menu. The MPU 532 sends a corresponding control signal to the CPU 52. The CPU 52 identifies the control signal received from the MPU 532, and sends a corresponding control signal to the external OSD unit 412 in order to set the basic parameters and assign the resources of the data of the external OSD menu, thereby generating data of the secondary menu of the external OSD menu.

In step S6, when the adjusting of the function items is completed, the user inputs an exit instruction to the inputting unit 52. The MPU 532 sends a corresponding signal to the CPU 42. The CPU 42 identifies the signal, and sends an exit signal to the memory 41. The memory 41 calls an exit program of the external OSD unit 412 to exit the external OSD menu. Accordingly, the display screen stops displaying the external OSD menu.

In summary, the OSD system 3 is capable of generating both the internal OSD menu and the external OSD menu. Typically, the internal OSD menu is much the same as an ordinary OSD menu of a conventional OSD system. For example, the internal OSD menu includes single-color text characters and still images. In contrast, the external OSD menu is colorful and dynamic. Thus, the settings of the display parameters of the display device 5 can be adjusted to desired values by operating either the internal OSD menu or the external OSD menu through the inputting unit 52, with selection of the internal OSD menu or the external OSD menu being at the discretion of the user.

It is to be further understood that even though numerous characteristics and advantages of preferred and exemplary embodiments have been set out in the foregoing description, together with details of structures and functions associated with the embodiments, the disclosure is illustrative only; and that changes may be made in detail (including in matters of arrangement of parts) within the principles of the invention to the full extent indicated by the broad general meaning of the terms in which the appended claims are expressed.

What is claimed is:

1. An on-screen display (OSD) system, comprising:
a display device comprising a micro processing unit (MPU) configured for providing a plurality of instruction signals according to external instructions received; and
a computer connected to the display device, the computer comprising:
a memory comprising an external OSD unit, the external OSD unit being configured for generating an external OSD menu, the external OSD menu being colorful and dynamic; and
a central processing unit (CPU) configured for identifying the instruction signals received from the MPU and providing control signals corresponding to the instruction signals;
wherein the external OSD unit is capable of setting and assigning data to generate the external OSD menu on receiving the control signals from the CPU, whereupon the external OSD menu is displayed on the display device.

2. The on-screen display system as claimed in claim 1, wherein the display device further comprises a video circuit configured for receiving video signals from an external circuit and processing the video signals in order to display corresponding images on the display device.

3. The on-screen display system as claimed in claim 2, wherein the video circuit comprises an internal OSD unit, the internal OSD unit being capable of generating an internal OSD menu according to a control signal provided by the MPU.

4. The on-screen display system as claimed in claim 3, wherein the internal OSD unit comprises a character library, a window library, a function program segment, and a motion program segment, which are used for generating the internal OSD menu.

5. The on-screen display system as claimed in claim 3, wherein the display device further comprises an inputting unit configured for generating instruction signals according to the external instructions received.

6. The on-screen display system as claimed in claim 5, wherein the internal OSD menu comprises a function item for selecting whether to establish an active connection between the computer and the display device.

7. The on-screen display system as claimed in claim 3, wherein the video circuit further comprises a video processing unit configured for scaling internal OSD data received from the internal OSD unit and scaling external OSD data signals received from the computer, and providing a plurality of signals to the display device according to the scaled internal OSD data or the scaled external OSD data signals.

8. The on-screen display system as claimed in claim 7, wherein the video circuit further comprises an analog to digital converter configured for receiving video signals, horizontal synchronization signals, and vertical synchronization signals, converting the video signals into digital video signals, and converting the horizontal synchronization signals and vertical synchronization signals into digital synchronization signals.

9. The on-screen display system as claimed in claim 7, wherein the computer further comprises a display controller configured for receiving the data of the external OSD menu, transforming the data into the external OSD data signals, and transmitting the external OSD data signals to the video processing unit.

10. The on-screen display system as claimed in claim 6, wherein the display device further comprises a first communication interface, and the computer further comprises a second communication interface, the first communication interface being connectable to the second communication interface, and when an active connection is established between the computer and the display device, various signals are transmitted between the first communication interface and the second communication interface.

11. An on-screen system (OSD) controlling method employed using an OSD system, the OSD system comprising a display device capable of generating an internal OSD menu and a computer capable of generating an external OSD menu, the display device comprising an inputting unit configured for providing a plurality of instruction signals to the computer according to a user's instruction, the computer comprising a central processing unit (CPU) configured for identifying the instruction signals and providing corresponding control signals and a memory configured for storing the external OSD menu, the method comprising:
connecting the computer and the display device;
generating and displaying the internal OSD menu;
establishing an active connection between the computer and the display device by operating the internal OSD menu;
detecting whether instruction signals generated in the display device are transmitted to the computer;
the CPU identifying the instruction signals and generating corresponding control signals, when the instruction signals are transmitted to the computer;
the CPU maintaining a waiting mode when the instruction signals are not transmitted to the computer;
generating the external OSD menu and displaying the external OSD menu on the display device according to the control signals provided by the CPU.

12. The method as claimed in claim 11, further comprising installing application software and allowing reading of an initial program of the memory and a driver program of the memory, before establishing the active connection between the computer and the display device.

13. The method as claimed in claim 11, wherein the establishing of the active connection between the computer and the display device is accomplished by a user's instruction input to the inputting unit via selection of a corresponding function item included in the displayed internal OSD menu.

14. The method as claimed in claim 13, wherein the display device further comprises a micro processing unit (MPU) which receives the user's instruction, the MPU sends a corresponding identification signal to the CPU, and the CPU receives and processes the identification signal, generates a corresponding control signal, and transmits the control signal to the memory.

15. The method as claimed in claim 11, wherein the internal OSD menu includes a function item operable for establishing the active connection between the computer and the display device.

16. The method as claimed in claim 15, wherein the external OSD menu includes a function item operable for terminating the active connection between the computer and the display device, and the method further comprises a user selecting the termination function item, whereupon the external OSD menu ceases to be displayed on the display device.

17. An OSD system capable of displaying OSD images, the OSD system comprising:
a display device;
a first OSD unit and a second OSD unit, the first OSD unit configured for providing a first OSD menu for display on the display device, the second OSD unit being configured for providing a second OSD menu for display on the display device, at least one of the first and second OSD menus being a colorful and dynamic display;
wherein both the first and second OSD menus are selectively available for display on the display device to adjust parameters of images displayed on the display device, with one of the first and second OSD menus being available through selection of a function item provided by the other one of the first and second OSD menus.
